(19) United States
(12) Patent Application Publication
(10) Pub. No.: US 2022/0283859 A1
(43) Pub. Date: Sep. 8, 2022

(54) METHOD AND DEVICE FOR PROCESSING DATA

(71) Applicant: Robert Bosch GmbH, Stuttgart (DE)

(72) Inventors: Tobias Gehrmann, Stuttgart (DE); Andreas Heyl, Weil Der Stadt (DE); Andreas Nauerz, Stuttgart (DE); Eike Martin Thaden, Renningen (DE); Markus Schweizer, Vaihingen/Enz (DE); Peter Munk, Renningen (DE)

(21) Appl. No.: 17/681,189

(22) Filed: Feb. 25, 2022

(30) Foreign Application Priority Data
Mar. 3, 2021 (DE) 10 2021 202 057.7

(51) Int. Cl. G06F 9/50

(52) U.S. Cl. CPC G06F 9/505; G06F 9/5083

(57) ABSTRACT

A computer-implemented method for processing data for applications in the field of cloud computing and/or edge computing, for vehicles. The method includes: providing multiple computing services using at least two different hardware resources, and using the multiple computing services.

### FIELD

The present invention relates to a method for processing data.

Moreover, the present invention relates to a device for processing data.

### SUMMARY

Exemplary specific embodiments of the present invention relate to a method, for example a computer-implemented method, for processing data, for example for applications in the field of cloud computing and/or edge computing, for example for vehicles, including: providing multiple computing services using at least two different hardware resources, and using the multiple computing services. As a result, in further exemplary specific embodiments the safety may be increased, so that, for example, safety-critical applications or computations with the aid of the multiple computing services may also be reliably carried out.

In further exemplary specific embodiments of the present invention, it is provided that at least two of the multiple computing services in each case use different resources, for example hardware resources and/or software resources.

In further exemplary specific embodiments of the present invention, it is provided that at least one of the multiple computing services is designed to carry out at least one of the following elements: a) a computer program, b) a computation task, c) evaluating an algorithm, for example in the field of artificial intelligence or machine learning, d) inference.

In further exemplary specific embodiments of the present invention, it is provided that at least two of the multiple computing services are redundant with one another, for example at least in part.

In further exemplary specific embodiments of the present invention, it is provided that the method includes: providing a first processing unit, for example a processing pipeline, a first number of, for example, redundant computing services, for example of the multiple computing services, being associated with the first processing unit, and optionally providing a second processing unit, for example a processing pipeline, a second number of, for example, redundant computing services, for example of the multiple computing services, being associated with the second processing unit.

In further exemplary specific embodiments of the present invention, it is provided that the method includes at least one of the following elements: a) scaling of resources associated with at least one computing service of the multiple computing services, b) scaling of resources associated with at least one processing unit, the scaling of the resources encompassing, for example, a decrease or an increase in the resources, c) scaling a number of the processing units.

In further exemplary specific embodiments of the present invention, it is provided that the scaling is carried out during operation, for example during the use of the multiple computing services, for example during the use of at least one processing unit associated with the multiple computing services.

In further exemplary specific embodiments of the present invention, it is provided that the method includes: carrying out load balancing, for example between the multiple computing services and/or between multiple processing units.

In further exemplary specific embodiments of the present invention, it is provided that the scaling and/or the carrying out of the load balancing are/is carried out based on at least one of the following elements: a) number of requests, for example by clients, b) at least one predefinable criterion, for example a quality criterion, for example at least one quality criterion associated with an application or a service, c) at least one safety requirement.

In further exemplary specific embodiments of the present invention, it is provided that the method includes: using hardware resources of at least one of the following types: a) a computer that includes one or multiple processor cores, b) a processor, for example a central processing unit CPU, c) a graphics processing unit GPU, d) a programmable logic circuit, for example an FPGA, e) a hardware circuit, f) an application-specific circuit, for example an ASIC, g) a microcontroller, h) a cloud system.

In further exemplary specific embodiments of the present invention, it is provided that the method includes: ascertaining and/or at least temporarily storing an identification that characterizes at least one hardware resource of the two different hardware resources, and optionally evaluating or validating a configuration of the hardware resources, and optionally assessing the validity of results that are obtained or obtainable with the aid of the multiple computing services, for example computation results.

In further exemplary specific embodiments of the present invention, it is provided that the method includes: ascertaining and/or monitoring the integrity of at least one of the following elements: a) at least one computing service, for example of the multiple computing services, b) at least one hardware resource, for example of the at least two different hardware resources, c) at least one processing unit.

In further exemplary specific embodiments of the present invention, it is provided that the method includes: exchanging at least one of the following elements: a) at least one computing service, for example of the multiple computing services, b) at least one hardware resource, for example of the at least two different hardware resources, c) at least one processing unit, the exchanging taking place, for example, when an error has been detected, for example a violation of the integrity has been ascertained or detected.

In further exemplary specific embodiments of the present invention, it is provided that the method includes: identifying a faulty component, and optionally using the faulty component, at least temporarily, for example to assess a state or the integrity of the faulty component.

In further exemplary specific embodiments of the present invention, it is provided that the method includes: shifting a, for example geographical, position of at least one of the following elements: a) at least one computing service, for example of the multiple computing services, b) at least one hardware resource, for example of the at least two different hardware resources, c) at least one processing unit, for example based on at least one of the following elements: A) a, for example geographical, position of at least one user of at least one of the multiple computing services, for example a client, B) a signal propagation time between the at least one user and at least one of the multiple computing services.

In further exemplary specific embodiments of the present invention, it is provided that the method includes: providing a computation task for a vehicle, for example a motor vehicle, for example the computation task to be carried out redundantly and outside the vehicle, carrying out the computation task, for example redundantly, for example with the aid of redundant software resources and/or with the aid of redundant hardware resources, and outside the vehicle, for example with the aid of at least two computing services of the multiple computing services, for example the at least two computing services each being associated with at least one edge server and/or at least one cloud server, for example multiple computation results being obtained.

In further exemplary specific embodiments of the present invention, the providing of the computation task for the vehicle is carried out, for example, by the vehicle or a component (a control unit, for example) of the vehicle.

In further exemplary specific embodiments of the present invention, the providing of the computation task for the vehicle is carried out, for example, by a unit external to the vehicle or by a unit other than the vehicle (for example, a control center, infrastructure component, digital twin of the vehicle, etc.).

In further exemplary specific embodiments of the present invention, it is provided that the method includes: transmitting the multiple computation results to the vehicle.

In further exemplary specific embodiments of the present invention, it is provided that the method includes: receiving the multiple computation results, for example in the vehicle, and comparing the multiple computation results, and based on the comparing, optionally verifying the multiple computation results (and optionally using the computation results), or optionally carrying out a compensation response (for example, discarding at least one of the multiple computation results and/or the computation task, error reporting, for example to a further component, for example of the vehicle, transferring at least one component or at least one system of the vehicle into a predefinable, for example safe, state).

Further exemplary specific embodiments of the present invention relate to a method that includes at least one of the following elements: a) providing a computation task for a vehicle, for example a motor vehicle, for example the computation task to be carried out redundantly and outside the vehicle, b) carrying out the computation task, for example redundantly, for example with the aid of redundant software resources and/or with the aid of redundant hardware resources, and outside the vehicle, for example with the aid of at least two computing services of the multiple computing services, for example the at least two computing services each being associated with at least one edge server and/or at least one cloud server, for example multiple computation results being obtained, c) transmitting the multiple computation results to the vehicle, d) receiving the multiple computation results, for example in the vehicle, e) comparing the multiple computation results, for example with the aid of a component of the vehicle, and optionally based on the comparing, f) verifying the multiple computation results, g) using the computation results, h) carrying out a compensation response (for example, discarding at least one of the multiple computation results and/or the computation task, error reporting, for example to a further component, for example of the vehicle, transferring at least one component or at least one system of the vehicle into a predefinable, for example safe, state).

Further exemplary specific embodiments of the present invention relate to a device for carrying out the method according to the specific embodiments.

Further exemplary specific embodiments of the present invention relate to a system, for example a cloud system, that includes at least one device according to the specific embodiments and at least two hardware resources that are for example different from one another.

Further exemplary specific embodiments of the present invention relate to a method, for example a computer-implemented method, for processing data, for example for vehicles, including: using at least one computing service that is provided or providable with the aid of a method according to the specific embodiments and/or with the aid of a device according to the specific embodiments and/or a system according to the specific embodiments.

In further exemplary specific embodiments of the present invention, it is provided that the method further includes: sending a request, for example a request for the computation of a computation task, and optionally receiving at least one answer that, for example, characterizes a result of the computation.

In further exemplary specific embodiments of the present invention, it is provided that the method further includes at least one of the following elements: a) for example, in the case of receiving multiple answers, comparing the multiple answers, b) for example, in the case of receiving multiple answers, selecting at least one of the multiple answers.

In further exemplary specific embodiments of the present invention, the results or the answers may be discarded when a deviation of the multiple results or answers from one another is detected. For example, in further exemplary specific embodiments, when a deviation of the multiple results or answers from one another is detected, at least one new request may be made, and/or at least one response of the vehicle, for example, independently of the results, may take place (for example, transfer into a “safe state”).

Further exemplary specific embodiments of the present invention relate to a computer-readable memory medium that includes commands which, when executed by a computer, prompt the computer to carry out the method according to the specific embodiments.

Further exemplary specific embodiments of the present invention relate to a computer program that includes commands which, when the program is executed by a computer, prompt the computer to carry out the method according to the specific embodiments.

Further exemplary specific embodiments of the present invention relate to a data carrier signal that transfers and/or characterizes the computer program according to the specific embodiments.

Further exemplary specific embodiments of the present invention relate to a vehicle, for example a motor vehicle, that includes at least one device according to the specific embodiments.

Further exemplary specific embodiments of the present invention relate to a use of the method according to the specific embodiments and/or of the device according to the specific embodiments and/or of the system according to the specific embodiments and/or of the computer-readable memory medium according to the specific embodiments and/or of the computer program according to the specific embodiments and/or of the data carrier signal according to the specific embodiments and/or of the vehicle according to the specific embodiments for at least one of the following elements: a) avoiding a systematic multiple failure, b) avoiding common cause failures, c) detecting errors, for example during an execution of a computer program, d) providing at least one secure computing service and/or at least one secure processing unit, e) enabling a secure and/or reliable execution of software, for example safety-critical software, for example using a cloud system, f) transferring computations, for example safety-critical computations of a vehicle, from a system of the vehicle, for example from a control unit and/or vehicle computer of the vehicle, for example into a remotely situated system, for example a cloud system and/or an edge computing system or at least one edge server, g) using resources of at least one edge server and/or at least one cloud server for redundantly carrying out a computation task for a vehicle outside the vehicle, and assessing computation results that are obtained from the redundant carrying out of the computation task, for example comparing the obtained computation results by a component, for example a control unit, of the vehicle.

Further features, application options, and advantages of the present invention result from the following description of exemplary embodiments of the present invention, illustrated in the figures. All described or illustrated features, alone or in any arbitrary combination, constitute the subject matter of the present invention, regardless of their wording or illustration in the description or figures, respectively.

### BRIEF DESCRIPTION OF THE DRAWINGS

FIG. 1 schematically shows a simplified flowchart according to exemplary specific embodiments of the present invention.

FIG. 2 schematically shows a simplified flowchart according to further exemplary specific embodiments of the present invention.

FIG. 3A schematically shows a simplified block diagram according to further exemplary specific embodiments of the present invention.

FIG. 3B schematically shows a simplified block diagram according to further exemplary specific embodiments of the present invention.

FIG. 4 schematically shows a simplified block diagram according to further exemplary specific embodiments of the present invention.

FIG. 5 schematically shows a simplified flowchart according to further exemplary specific embodiments of the present invention.

FIG. 6 schematically shows a simplified flowchart according to further exemplary specific embodiments of the present invention.

FIG. 7 schematically shows a simplified flowchart according to further exemplary specific embodiments;

FIG. 8 schematically shows a simplified flowchart according to further exemplary specific embodiments of the present invention.

FIG. 9 schematically shows a simplified flowchart according to further exemplary specific embodiments of the present invention.

FIG. 10 schematically shows a simplified flowchart according to further exemplary specific embodiments of the present invention.

FIG. 11 schematically shows a simplified block diagram according to further exemplary specific embodiments of the present invention.

FIG. 12 schematically shows a simplified flowchart according to further exemplary specific embodiments of the present invention.

FIG. 13 schematically shows a simplified flowchart according to further exemplary specific embodiments of the present invention.

FIG. 14 schematically shows a simplified block diagram according to further exemplary specific embodiments of the present invention.

FIG. 15 schematically shows a simplified block diagram according to further exemplary specific embodiments of the present invention.

FIG. 16 schematically shows a simplified block diagram according to further exemplary specific embodiments of the present invention.

FIG. 17 schematically shows a simplified block diagram according to further exemplary specific embodiments of the present invention.

FIG. 18 schematically shows a simplified block diagram according to further exemplary specific embodiments of the present invention.

FIG. 19 schematically shows a simplified block diagram according to further exemplary specific embodiments of the present invention.

FIG. 20 schematically shows aspects of uses according to further exemplary specific embodiments of the present invention.

FIG. 21 schematically shows a simplified flowchart according to further exemplary specific embodiments of the present invention.

### DETAILED DESCRIPTION OF EXAMPLE EMBODIMENTS

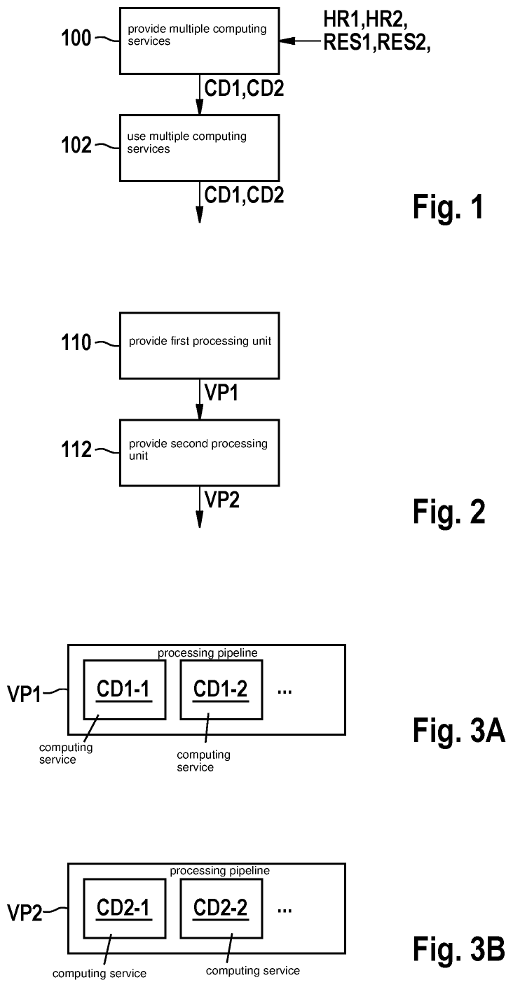

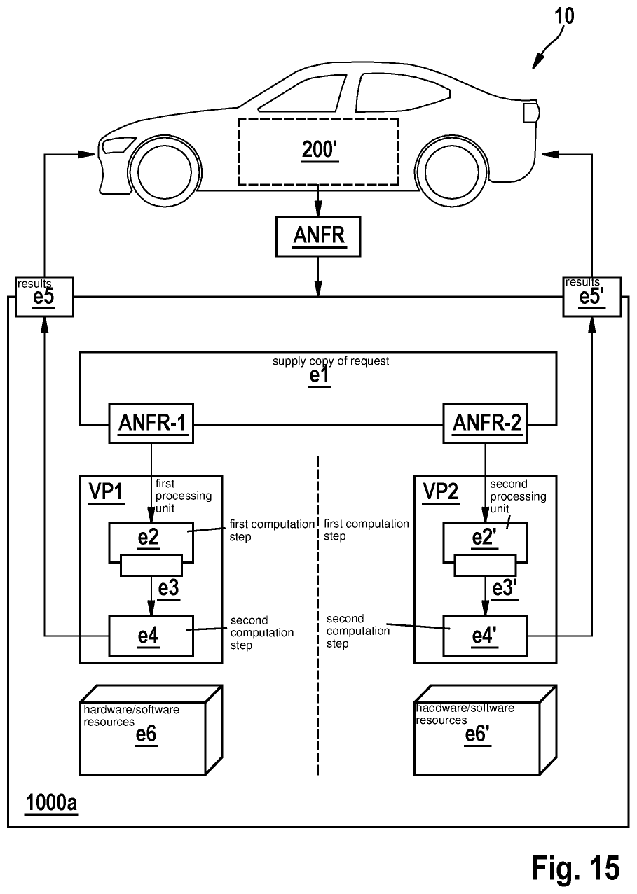

Exemplary specific embodiments (cf. FIG. 1) relate to a method, for example a computer-implemented method, for processing data, for example for applications in the field of cloud computing and/or edge computing, for example for vehicles 10 (FIG. 15), including: providing 100 (FIG. 1) multiple computing services CD1, CD2, using at least two different hardware resources HR1, HR2 (or in general, using at least two different (hardware and/or software) resources RES1, RES2), using 102 multiple computing services CD1, CD2. As a result, in further exemplary specific embodiments the safety may be increased, so that, for example, safety-critical applications or computations with the aid of multiple computing services CD1, CD2 may also be reliably carried out.

In further exemplary specific embodiments, it is provided that at least two of multiple computing services CD1, CD2 each use different resources RES1, RES2, for example hardware resources HR1, HR2 and/or software resources (not shown). In further exemplary specific embodiments, it is provided that at least one of multiple computing services CD1, CD2 is designed to carry out at least one of the following elements: a) a computer program, b) a computation task, c) evaluating an algorithm, for example in the field of artificial intelligence or machine learning, d) inference.

In further exemplary specific embodiments, it is provided that at least two of multiple computing services CD1, CD2 are redundant with one another, for example at least in part, i.e., for example at least temporarily execute the same computer programs and/or computations or the like.

In further exemplary specific embodiments (FIGS. 2, 3A, 3B), it is provided that the method includes: providing 110 a first processing unit, for example a processing pipeline VP1, a first number of, for example, redundant computing services CD1-1, CD1-2, for example of multiple computing services CD1, CD2, being associated with first processing unit VP1, and optionally providing 112 a second processing unit, for example a processing pipeline VP2, a second number of, for example, redundant computing services CD2-1, CD2-2, for example of multiple computing services CD1, CD2, being associated with second processing unit VP2.

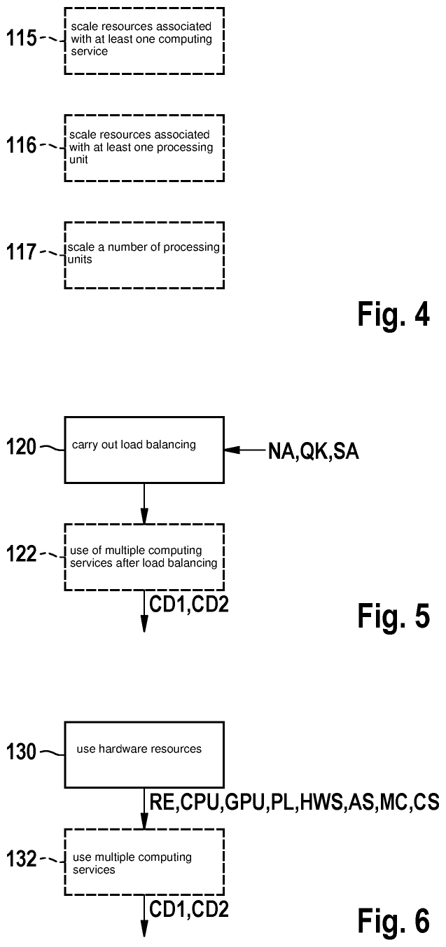

In further exemplary specific embodiments (FIG. 4), it is provided that the method includes at least one of the following elements: a) scaling 115 of resources (hardware and/or software resources, for example) associated with at least one computing service CD1, CD2 (FIG. 1) of the multiple computing services, b) scaling 116 of resources (hardware and/or software resources, for example) associated with at least one processing unit VP1, VP2 (FIGS. 2, 3A, 3B), scaling 115, 116 of the resources encompassing, for example, a decrease or an increase in the resources, c) scaling 117 a number of processing units VP1, VP2.

In further exemplary specific embodiments, it is provided that scaling 115, 116, 117 is carried out during operation, for example during the use of multiple computing services CD1, CD2, for example during the use of at least one processing unit VP1, VP2 associated with the multiple computing services.

In further exemplary specific embodiments (FIG. 5), it is provided that the method includes: carrying out 120 load balancing, for example between multiple computing services CD1, CD2 and/or between multiple processing units VP1, VP2. Optional block 122 symbolizes an optional use of multiple computing services CD1, CD2, for example after load balancing 120.

In further exemplary specific embodiments, it is provided that scaling 115, 116, 117 (FIG. 4) and/or carrying out 120 (FIG. 5) of the load balancing are/is carried out based on at least one of the following elements: a) number NA of requests, for example by clients, b) at least one predefinable criterion QK, for example quality criterion QK, for example at least one quality criterion QK associated with an application or a service, c) at least one safety requirement SA.

In further exemplary specific embodiments, for example a lowest possible latency or a smallest variation of a computation duration, etc., may be used as predefinable criterion QK.

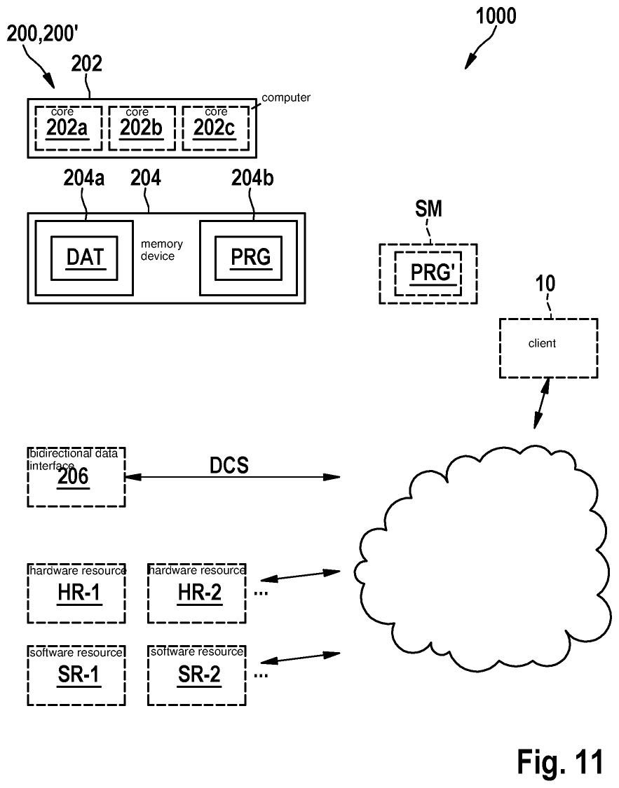

In further exemplary specific embodiments, it is provided to provide and/or apply and/or establish and/or adapt a configuration of a cloud system 1000, for example (FIGS. 11, 15, . . . ), that takes into account safety requirements, for example, based on the at least one safety requirement SA.

In further exemplary specific embodiments (FIG. 6), it is provided that the method includes: using 130 hardware resources of at least one of the following types: a) a computer RE that includes one or multiple processor cores, b) a central processing unit CPU, c) a graphics processing unit GPU (for example for training and/or carrying out or evaluating (inference) at least one artificial neural network ANN), d) a programmable logic circuit PL, for example a field programmable gate array FPGA, e) a hardware circuit HWS, f) an application-specific circuit AS, for example an ASIC, g) a microcontroller MC, h) a cloud system CS.

Optional block 132 symbolizes an optional use of multiple computing services CD1, CD2, for example based on one or multiple of the above-mentioned resources.

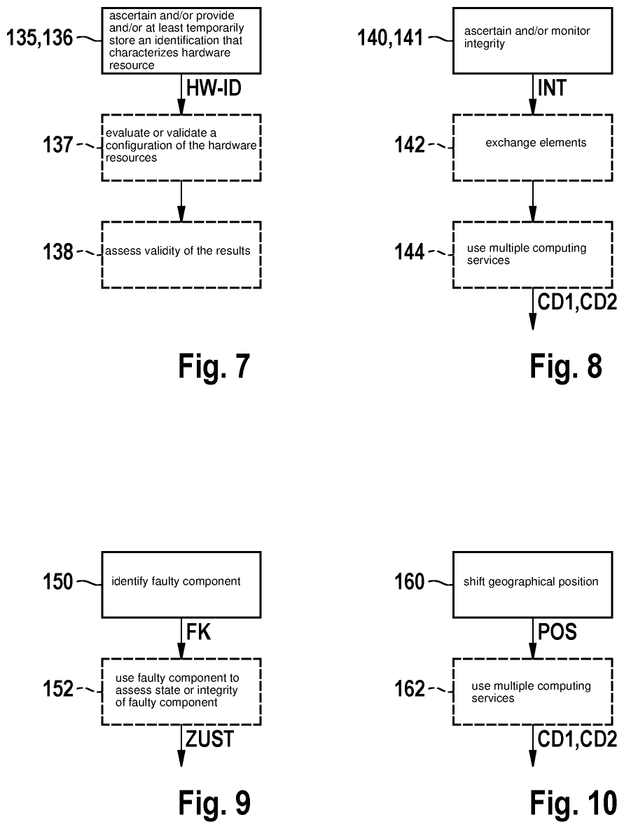

In further exemplary specific embodiments (FIG. 7), it is provided that the method includes: ascertaining 135 and/or providing and/or at least temporarily storing 136 an identification HW-ID that characterizes at least one hardware resource HR1 (FIG. 1) of the two different hardware resources HR1, HR2, and optionally evaluating 137 or validating a configuration of the hardware resources, and optionally assessing 138 the validity of results, for example computation results, that are obtained or obtainable with the aid of multiple computing services CD1, CD2.

In further exemplary specific embodiments, identification HW-ID may, for example, be (additionally) transmitted and for example, evaluated in subsequent processing steps, for example to ensure that computations actually have been carried out redundantly and/or to enable unambiguous identification of potentially faulty processing units.

In further exemplary specific embodiments (FIG. 8), it is provided that the method includes: ascertaining 140 and/or monitoring 141 integrity INT of at least one of the following elements: a) at least one computing service, for example of multiple computing services CD1, CD2, b) at least one hardware resource, for example of the at least two different hardware resources HR1, HR2, c) at least one processing unit VP1, VP2.

In further exemplary specific embodiments, it is provided that the method includes: exchanging 142 at least one of the following elements: a) at least one computing service, for example of multiple computing services CD1, CD2, b) at least one hardware resource, for example of the at least two different hardware resources HR1, HR2, c) at least one processing unit VP1, VP2, for example exchanging 142 being carried out when an error has been detected, for example a violation of integrity INT has been ascertained or detected (cf., for example, block 140 according to FIG. 8).

Optional block 144 symbolizes an optional use of multiple computing services CD1, CD2, for example after exchanging 142.

In further exemplary specific embodiments (FIG. 9), it is provided that the method includes: identifying 150 a faulty component FK (characterizable by hardware and/or software, for example), and optionally using 152 faulty component FK, at least temporarily, for example to assess a state ZUST or the integrity of faulty component FK.

In further exemplary specific embodiments, one or multiple statistical evaluations with regard to faulty components or erroneous computations may be carried out, for example to provide a diagnostic framework. In further exemplary specific embodiments, the diagnostic framework is designed to identify and/or replace faulty components FK of processing pipelines VP1, VP2, for example, and/or to replace an entire processing pipeline, for example during operation.

In further exemplary specific embodiments, faulty components FK may continue to be operated, for example to carry out redundant computations, for example to test whether the faulty component is continuously operating incorrectly or whether, for example, only a single error has occurred. In further exemplary specific embodiments, the computation results of such a faulty component FK to be tested are not used, at least initially, or at best are used for a comparison with computation results of non-faulty components. In further exemplary specific embodiments, if errors continue or occur anew, a faulty component FK may be deactivated in further exemplary specific embodiments. Otherwise, in further exemplary specific embodiments, faulty component FK may be, for example, regarded as no longer faulty and, for example, re-used as under normal conditions.

In further exemplary specific embodiments (FIG. 10), it is provided that the method includes: shifting 160a, for example geographical, position POS of at least one of the following elements: a) at least one computing service, for example of multiple computing services CD1, CD2, b) at least one hardware resource, for example of the at least two different hardware resources HR1, HR2, c) at least one processing unit VP1, VP2, for example based on at least one of the following elements: A) a, for example geographical, position of at least one user 10 (FIGS. 11, 15, . . . ) of at least one of multiple computing services CD1, CD2, for example a client, B) a signal propagation time between the at least one user and at least one of multiple computing services CD1, CD2.

Optional block 162 symbolizes an optional use of multiple computing services CD1, CD2, for example after shifting 160 of position POS.

For example, in further exemplary specific embodiments an edge computing infrastructure or a cloud computing system or edge computing system may be provided in which reliable processing pipelines VP1, VP2, for example having low latency, are utilizable. For example, for this purpose at least one hardware resource for processing pipelines VP1, VP2 may be selected, for example dynamically, which is situated as close to a client (for example, vehicle 10 or control unit or vehicle computer of vehicle 10), for example in the area of a base station of a wireless communication system, for example, in whose range of action the vehicle is situated.

In further exemplary specific embodiments, a configuration or resource planning (scheduling) of processing pipelines VP1, VP2 may, for example, “track” vehicle 10, for example processing pipelines VP1, VP2 being spatially, for example geographically, shifted based on a position of vehicle 10, so that, for example, communication-related latencies may be minimized.

In further exemplary specific embodiments, the shifting may encompass starting or restarting processing pipelines VP1, VP2, for example on a new edge server or edge computer which the vehicle has approached.

In further exemplary specific embodiments, the shifting may encompass a “handover” of processing pipelines VP1, VP2, for example from a first edge computer to a second edge computer. In further exemplary specific embodiments, such a handover may also include, for example, transmitting intermediate results of computations of processing pipelines VP1, VP2, for example from the first edge computer to the second edge computer, for example based on an application.

Further exemplary specific embodiments (FIG. 11) relate to a device 200, 200′ for carrying out the method according to the specific embodiments.

Device 200 includes a computer 202 (computer) that includes at least one processor core 202a, 202b, 202c and a memory device 204, associated with computer 202, for at least temporarily storing data DAT and/or computer programs PRG. Memory device 204 may include, for example, a volatile memory 204a (working memory (RAM), for example) and/or a nonvolatile memory 204b (flash EEPROM, for example).

In further preferred specific embodiments, it is provided that device 200 includes a preferably bidirectional data interface 206, for example for a data communication with at least one of computing services CD1, CD2 and/or at least one of processing pipelines VP1, VP2, and/or with associated hardware resources HR-1, HR-2, and/or with associated software resources SR-1, SR-2, and/or with at least one client 10, for example via a system for wireless data communication, for example in a public and/or private cellular mobile radio communications network, for example according to the 5G standard.

Further exemplary specific embodiments relate to a system 1000, for example a cloud system 1000, that includes at least one device 200, 200′ according to the specific embodiments and at least two hardware resources HR-1, HR-2 that are for example different from one another.

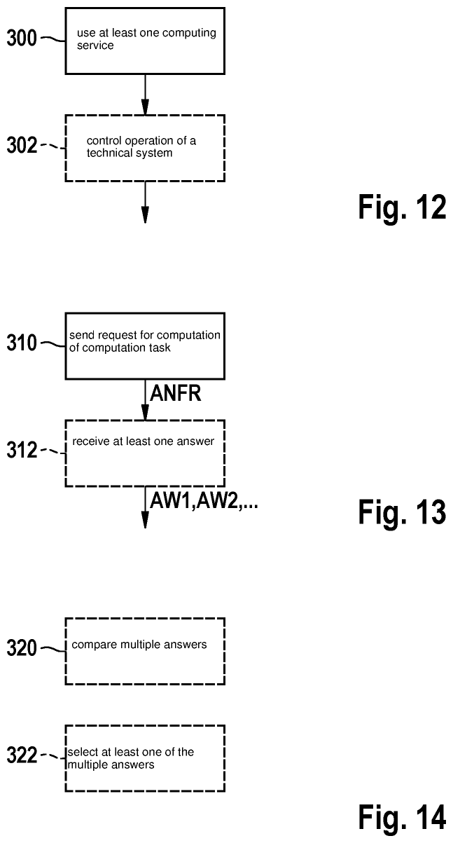

Further exemplary specific embodiments (FIG. 12) relate to a method, for example a computer-implemented method, for processing data, for example for vehicles 10, including: using 300 at least one computing service CD1, CD2 (FIG. 1) that is provided or providable with the aid of a method according to the specific embodiments and/or with the aid of a device 200 (FIG. 11) according to the specific embodiments and/or a system 1000 according to the specific embodiments. Optional block 302 according to FIG. 12 symbolizes an optional control of the operation of a technical system, for example of vehicle 10, based on the at least one computing service CD1, CD2 or computation results thus obtainable.

In further exemplary specific embodiments, the example of the sequence according to FIG. 12 may be utilized, for example, by a vehicle, for example a motor vehicle 10, for example to allow

CPU-intensive, in particular also safety-critical CPU-intensive, computation tasks (for aspects of autonomous driving, for example) with the aid of cloud system 1000.

In further exemplary specific embodiments (FIG. 13), it is provided that the method further includes: sending 310 a request

ANFR, for example a request for the computation of a computation task, for example to cloud system 1000 or device 200, and optionally receiving 312 at least one answer AW1, AW2, . . . , that for example characterizes a result of the computation.

In further exemplary specific embodiments (FIG. 14), it is provided that the method further includes at least one of the following elements: a) for example in the case of receiving 312 multiple answers AW1, AW2, comparing 320 (FIG. 14) multiple answers AW1, AW2, b) for example in the case of receiving 312 multiple answers AW1, AW2, selecting 322 at least one of multiple answers AW1, AW2.

In further exemplary specific embodiments, for example a device 200′ (similar to device 200, for example) may be provided that is designed to carry out aspects according to FIGS. 12, 13, 14. Device 200′ may be used in a vehicle 10, for example.

Further exemplary specific embodiments relate to a computer-readable memory medium SM (FIG. 11), including commands PRG which, when executed by a computer 202, prompt the computer to carry out the method according to the specific embodiments.

Further exemplary specific embodiments relate to a computer program PRG that includes commands which, when the program is executed by a computer 202, prompt the computer to carry out the method according to the specific embodiments.

Further exemplary specific embodiments relate to a data carrier signal DCS that transfers and/or characterizes computer program PRG according to the specific embodiments.

Further exemplary specific embodiments (FIG. 15) relate to a vehicle 10, for example a motor vehicle, that includes at least one device 200, 200′ according to the specific embodiments.

Further exemplary specific embodiments and aspects, each of which may be combined, individually or in combination with one another, with at least one of the specific embodiments described above by way of example are described below with reference to FIGS. 15 through 19.

FIG. 15 schematically shows a simplified block diagram according to further exemplary specific embodiments. Reference numeral 10 symbolizes a motor vehicle that includes a device 200′ that is designed, for example, according to FIG. 11 or similarly thereto.

In further exemplary specific embodiments, a secure execution of safety-critical software, for example, utilizing a cloud system 1000a may take place according to the specific embodiments, for example for executing the software, computations that are to be performed being redundantly carried out, for example multiple times, and the results thus obtained being compared to one another.

In further exemplary specific embodiments, a data exchange or a data communication between a client, for example vehicle 10, and cloud system 1000a, or computing services CD1, CD2 (FIG. 1) that are providable with the aid of cloud system 1000a, or processing units VP1, VP2 may be protected, for example by use of error correction codes (for example, check sums, for example for detecting and/or correcting errors), counters (for example, for detecting data losses, for example packet losses, and/or repeated transfers of data that are possibly already outdated).

In further exemplary specific embodiments, a scenario may take place as follows, for example: A request ANFR for computation, for example together with appropriate input data, is initially sent from client 10 to cloud system 1000a or to a corresponding service of cloud system 1000a, for example via a wireless communication system 10 (FIG. 11), for example via at least one edge server (not shown) which may, for example, include device 200 or be in data connection with device 200.

In further exemplary specific embodiments, for processing request ANFR, n number of instances (also referred to below as “copy” or “replica” for simplicity), where n is greater than or equal to 2, are executed by processing units VP1, VP2, for example by hardware and/or software resources e6, e6′, which in further exemplary specific embodiments are organizable or providable, for example, in the form of a data center or computing center. In further exemplary specific embodiments, different hardware and/or software resources e6, e6′ are associated in each case with processing units VP1, VP2. It is thus ensurable by the data center that each of processing units VP1, VP2, for example, shares no memory resources and/or processor resources with other processing units VP1, VP2, thus limiting errors in the resources in question to the particular processing unit, but not impairing other processing units, which for example are processing same request ANFR.

In further exemplary specific embodiments, hardware resources e6 may be provided in the form of a server, for example, which in further exemplary specific embodiments includes, for example, 16 processor cores and for example four graphics processing units GPUs. In further exemplary specific embodiments, hardware resources e6′ may have a design that is identical or similar to hardware resources e6. In the present case, hardware resources e6′ include a server, for example, which in further exemplary specific embodiments includes, for example, 48 processor cores and for example 16 graphics processing units GPUs.

In further exemplary specific embodiments, a corresponding copy ANFR-1, ANFR-2 of request ANFR is suppliable to each processing unit VP1, VP2, for example with the aid of block e1, which in further exemplary specific embodiments may also carry out load balancing.

In further exemplary specific embodiments, each copy VP1, VP2 ascertains or computes the corresponding result for request ANFR, ANFR-1, ANFR-2, for example by carrying out the appropriate computations, for example completely independently of the other copies that are processing same request ANFR.

Block e2 symbolizes by way of example a first computation step of first processing unit VP1, block e3 symbolizes by way of example an intermediate result of first computation step e2, and block e4 symbolizes by way of example a second computation step of first processing unit VP1. Blocks e2′, e3′, e4′ of second processing unit VP2 correspond by way of example to blocks e2, e3, e4, respectively, of first processing unit VP1.

As soon as all copies VP1, VP2 have completed their computations, n number of results e5, e5′ are available. In further exemplary specific embodiments, processing units VP1, VP2 may also provide intermediate results e3, e3′, for example for a handover to some other edge computer, prior to finalizing results e5, e5′.

In further exemplary specific embodiments, results e5, e5′ and/or intermediate results e3, e3′ may be compared to one another, for example by client 10, for example a device 200′ (cf. also FIG. 11) of client 10 (FIG. 15), for example in order to validate them.

In further exemplary specific embodiments, if the result of the comparison is negative (in the case of different results e5, e5′, for example), one or multiple of the following for example, configurable, responses may be carried out: a) discarding the, for example all, results or intermediate results, for example without transferring them to a “caller” (this behavior may also be referred to, for example, as “fail-silent” behavior, due to the fact that the caller, via the absence of the results within a predefinable time, is implicitly informed that an error is present), b) transferring the, for example all, results or intermediate results, for example with the information that an error is possibly present, c) if more than two redundant computations have been carried out, transferring the result that occurs most frequently (“voting”).

In further exemplary specific embodiments, the redundant configuration allows many possible reasons for erroneous computations, for example constant errors of hardware components such as processors or processor cores, memory, undesirable, for example internal, states of software stacks (for example, for the operating system, drivers, firmware, etc.), for example caused by previous hardware and/or software errors, to be avoided.

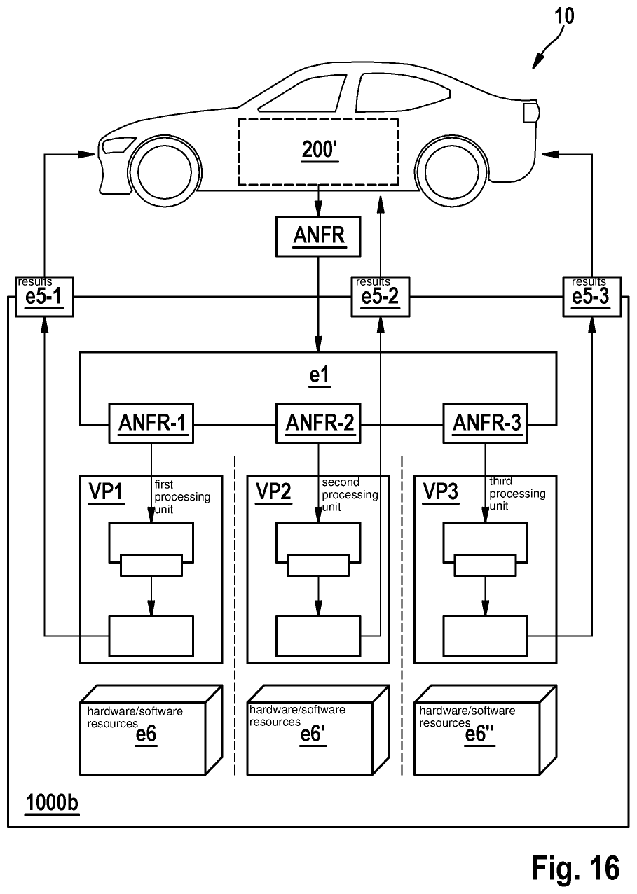

FIG. 16 schematically shows a block diagram according to further exemplary specific embodiments. Unlike configuration 1000a according to FIG. 15, configuration 1000b according to FIG. 16 includes three processing pipelines VP1, VP2, VP3 with associated hardware or software resources e6, e6′, e6″, respectively, which provide three results e5-1, e5-2, e5-3, for example based on requests ANFR-1, ANFR-2, ANFR-3.

In further exemplary specific embodiments, according to FIG. 16, validation of results e5-1, e5-2, e5-3 takes place not in cloud system 1000b, but rather, is carried out, for example, by device 200′ of vehicle 10, for example with the aid of voting. This has the advantage that a complex and possibly error-prone voting mechanism is not set up in cloud system 1000b.

In further exemplary specific embodiments, a voting mechanism of device 200′ may select, for example, the particular result of the three results e5-1, e5-2, e5-3 that occurs at least twice in results e5-1, e5-2, e5-3. If none of the results occurs at least twice in results e5-1, e5-2, e5-3, for example an error response may be initiated.

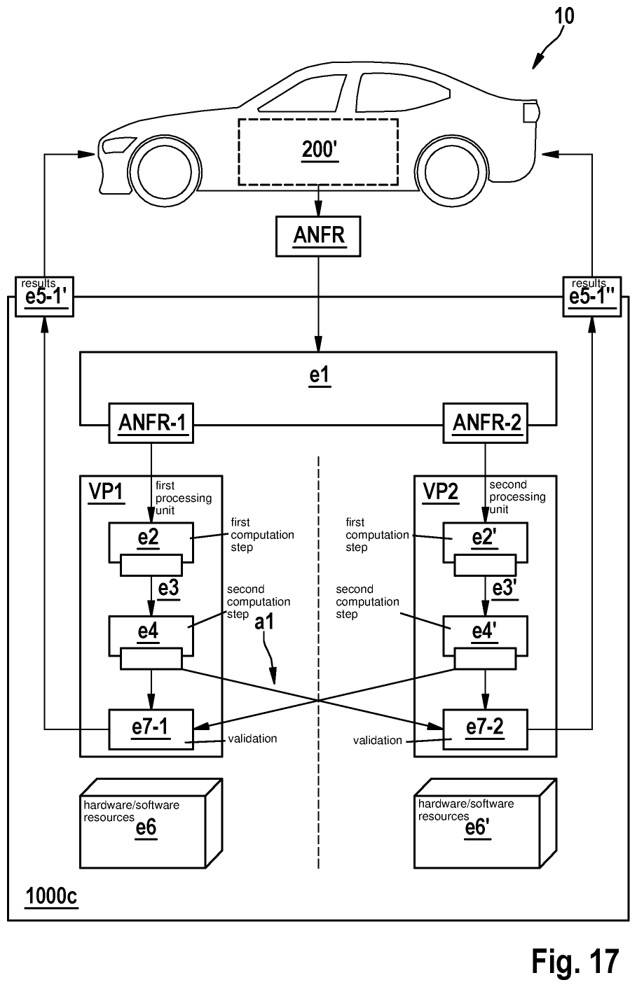

In further exemplary specific embodiments, for example a software-based validation of the correctness of results e7-1, e7-2 may take place in cloud system 1000b (cf. FIG. 17). For this purpose, the two processing units VP1, VP2 present by way of example may, for example, exchange intermediate results with one another (cf. block arrows a1). Accordingly, cloud system 1000b may provide for client 10, results e5-1′, e5-1″ that are already validated in the cloud, for example.

In further exemplary specific embodiments, for example a voting mechanism (“voter”) may be provided in cloud system 1000b.

In further exemplary specific embodiments, for example for each of the n number of (in the present case, two by way of example) copies VP1, VP2, a corresponding instance of the voter may be provided which, for example, is isolated from the, for example all, other copies and/or voters, for example by allocating various resources.

In further exemplary specific embodiments, each voter may wait for a predefinable time for results of copies VP1, VP2, and as soon as sufficient results have arrived (for example, two results for comparing without voting, and more than n/2 results for voting), comparing/voting is carried out which is for example configurable, for example based on a bit-by-bit comparison or a similarity.

In further exemplary specific embodiments, the result is delivered to caller 10 after successful comparing/voting.

Otherwise, an action that is configurable, for example, an error response, for example, may be carried out, for example according to the fail-silent principle or by actively informing caller 10 and optionally restarting the (entire, for example) computation.

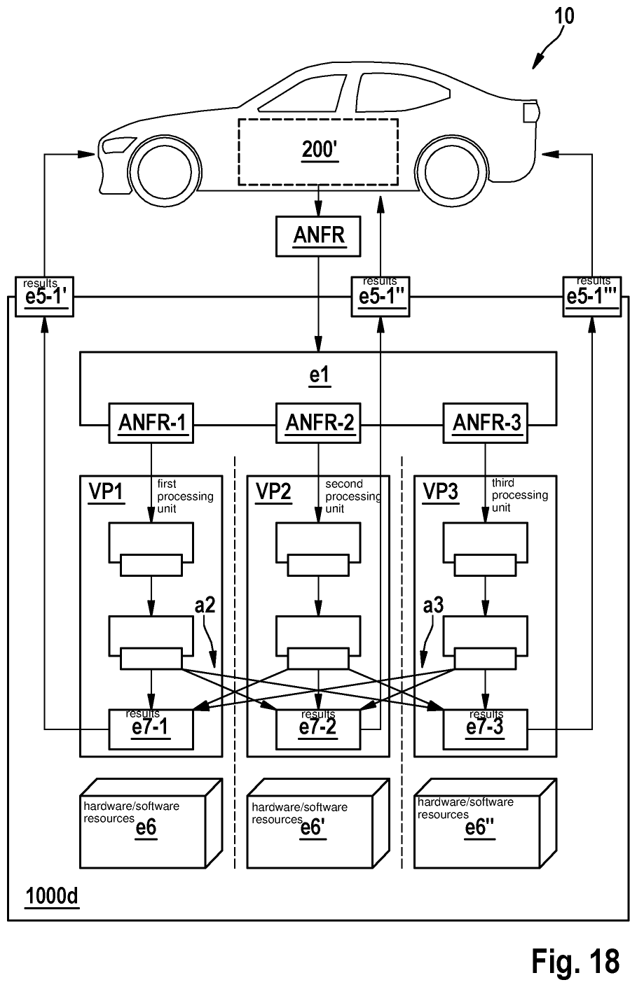

FIG. 18 schematically shows a block diagram of a cloud system 1000d according to further exemplary specific embodiments, in which the three processing units VP1, VP2, VP3 compare their intermediate results and/or results with one another (cf. block arrows a2, a3 and blocks e7-1, e7-2, e7-3), results e5-1′, e5-1″, e5-1″' that are already compared being outputtable.

In further exemplary specific embodiments, resources e6″ of at least one processing unit VP3 may also, for example, be significantly larger or more powerful, for example including 96 processor cores and/or 8 GPUs, compared, for example, to 16 or 48 processor cores (e6 or e6′) or 4 or 16 GPUs (e6 or e6′), which in further exemplary specific embodiments enables efficient scaling.

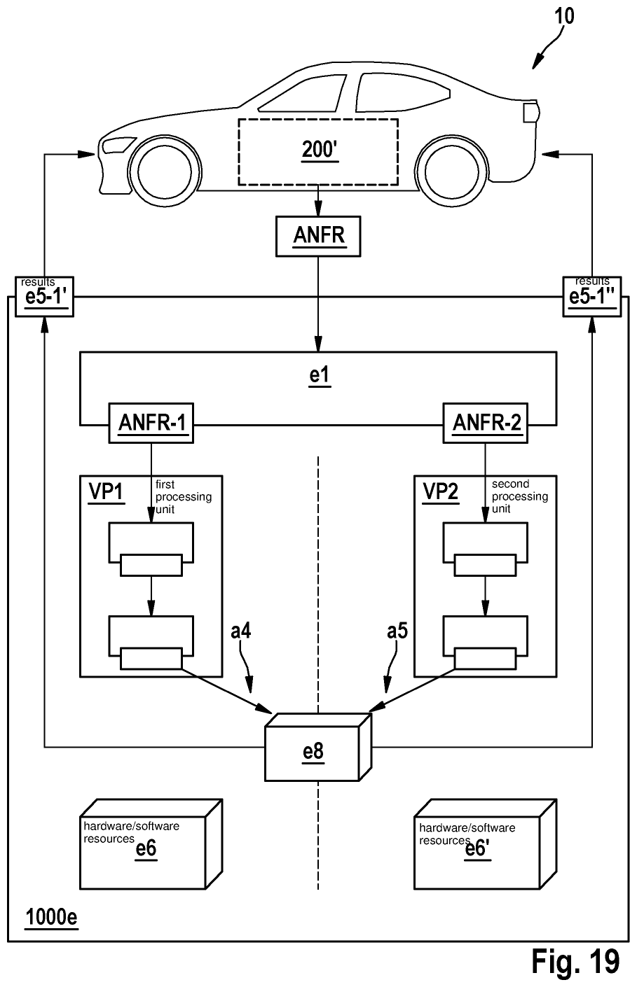

FIG. 19 schematically shows a block diagram of a cloud system 1000e according to further exemplary specific embodiments, in which two processing units VP1, VP2 compare their intermediate results and/or results to one another; cf. block arrows a4, a5 and block e8, which involve, for example, an embedded system or a microcontroller, for example an automotive microcontroller, for example with specialized hardware (for example, hardened against errors caused, for example, by hard radiation, etc.).

Block e8 may, for example, be arbitrarily situated in the hardware resources of cloud system 1000e, for example also in one or multiple edge servers (not shown), and with regard to functional safety may, for example, have a more secure design than resources e6, e6′.

In further exemplary specific embodiments, block e8 may represent a trustworthy instance that is integratable, for example, into servers of data centers. As a result, the requested computations may, for example, still be carried out by resources e6, e6′ of processing units VP1, VP2, which generally are significantly more powerful, whereas, for example, comparing or voting may be carried out by block e8. This advantageously allows trustworthy results of the comparing/voting to be provided in cloud system 1000e.

Based on the comparing/voting by block e8, for example an error response (for example, restarting the computations for request ANFR) may optionally be initiated.

In further exemplary specific embodiments, the results of the comparing/voting, for example together with the results, may also be transmitted to client 10, for example an (optionally additional) check sum that is ascertained by block e8, for example, being usable. Errors in transmitting to client 10 are efficiently detectable via this check sum.

In further exemplary specific embodiments, a protocol on used resources e6, e6′, etc., for example on all resources used for a certain computation, may be prepared. In further exemplary specific embodiments, the protocol may, for example, provide for the creation or addition of metadata, for example for intermediate results or results, that characterize at least one of the following elements: identification (ID) of a processor or processor core, computer name, ID(s) of the GPU(s).

In further exemplary specific embodiments, the protocol or data therefrom may also be used to ensure that no shared resources for the various processing units are used, for example by comparing the protocols/data.

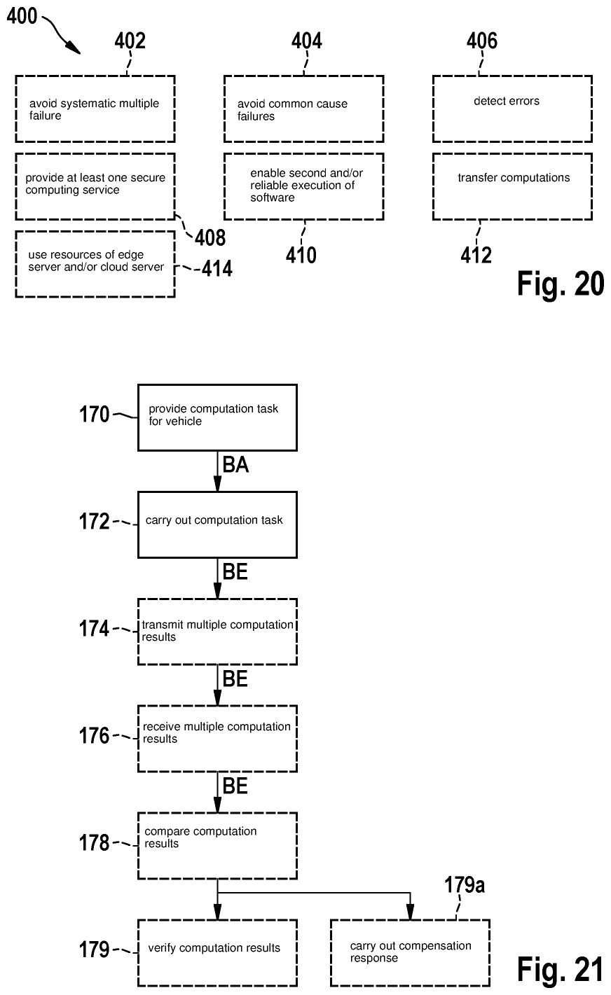

Further exemplary specific embodiments (FIG. 20) relate to a use 400 of the method according to the specific embodiments and/or of device 200, 200′ according to the specific embodiments and/or of system 1000 according to the specific embodiments and/or of computer-readable memory medium SM according to the specific embodiments and/or of computer program PRG according to the specific embodiments and/or of data carrier signal DCS according to the specific embodiments and/or of vehicle 10 according to the specific embodiments for at least one of the following elements: a) avoiding 402 a systematic multiple failure, b) avoiding 404 common cause failures, c) detecting 406 errors, for example during an execution of a computer program, d) providing 408 at least one secure computing service and/or at least one secure processing unit, e) enabling 410 a secure and/or reliable execution of software, for example safety-critical software, for example using a cloud system 1000, f) transferring 412 computations, for example safety-critical computations of a vehicle 10, from a system of the vehicle, for example from a control unit and/or vehicle computer of the vehicle, for example into a remotely situated system, for example a cloud system 1000 and/or an edge computing system or at least one edge server, g) using 414 resources of at least one edge server and/or at least one cloud server for redundantly carrying out a computation task BA (FIG. 21) for a vehicle 10 outside vehicle 10, and assessing computation results BE that are obtained from the redundant carrying out of computation task BA, for example comparing obtained computation results BE by a component 200′, for example a control unit, of vehicle 10.

In further exemplary specific embodiments (FIG. 21), it is provided that the method includes: providing 170 a computation task BA for a vehicle 10, for example a motor vehicle, for example computation task BA to be carried out redundantly and outside vehicle 10, carrying out 172 computation task BA, for example redundantly, for example with the aid of redundant software resources SR-1, SR-2 (FIG. 11) and/or with the aid of redundant hardware resources HR-1, HR-2, and outside vehicle 10, for example with the aid of at least two computing services CD-1, CD-2 of multiple computing services CD-1, CD-2 (FIG. 1), for example the at least two computing services CD-1, CD-2 each being associated with at least one edge server and/or at least one cloud server, for example multiple computation results BE being obtained.

In further exemplary specific embodiments, providing 170 of computation task BA for vehicle 10 is carried out, for example, by vehicle 10 or a component (control unit, for example) of the vehicle.

In further exemplary specific embodiments, providing 170 of computation task BA for the vehicle is carried out, for example, by a unit (not shown) external to the vehicle or by some unit other than vehicle 10 (for example, a control center, infrastructure component, digital twin of the vehicle, etc.).

In further exemplary specific embodiments, it is provided that the method includes: transmitting 174 multiple computation results BE to vehicle 10.

In further exemplary specific embodiments, it is provided that the method includes: receiving 176 multiple computation results BE, for example in vehicle 10, and optionally comparing 178 the multiple computation results BE, and based on comparing 178, optionally verifying 179 the multiple computation results (and optionally using the computation results), or optionally carrying out 179a a compensation response such as discarding at least one of multiple computation results BE and/or computation task BA, error reporting, for example to a further component, for example of the vehicle, transferring at least one component or at least one system of vehicle 10 into a predefinable, for example safe, state.

1-29 (canceled)

30. A computer-implemented method for processing data, comprising:
providing multiple computing services using at least two different hardware resources; and
using the multiple computing services.

31. The method as recited in claim 30, wherein at least two of the multiple computing services each use different resources, the different resources including hardware resources and/or software resources.

32. The method as recited in claim 30, wherein at least one of the multiple computing services is configured to carry out at least one of the following elements: a) a computer program, b) a computation task, c) evaluating an algorithm in the field of artificial intelligence or machine learning, d) inference.

33. The method as recited in claim 30, wherein at least two of the multiple computing services are redundant with one another at least in part.

34. The method as recited in claim 30, further comprising:
providing a first processing unit, a first number of redundant computing services of the multiple computing services being associated with the first processing unit; and
providing a second processing unit, a second number of redundant computing services of the multiple computing services, being associated with the second processing unit.

35. The method as recited in claim 30, further comprising at least one of the following steps:
a) scaling of resources associated with at least one computing service of the multiple computing services;
b) scaling of resources associated with at least one processing unit, the scaling of the resources encompassing a decrease or an increase in the resources, and
c) scaling a number of processing units.

36. The method as recited in claim 35, wherein the scaling is carried out during the use of the multiple computing services, including during the use of at least one processing unit associated with the multiple computing services.

37. The method as recited in claim 35, further comprising:
carrying out load balancing between the multiple computing services and/or between multiple processing units.

38. The method as recited in claim 37, wherein the scaling and/or the carrying out of the load balancing is carried out based on at least one of the following elements: a) number of requests by clients, b) at least one predefinable criterion including at least one quality criterion associated with an application or a service, c) at least one safety requirement.

39. The method as recited in claim 30, further comprising:
using hardware resources of at least one of the following types: a) a computer that includes one or multiple processor cores, b) a central processing unit, c) a graphics processing unit, d) a programmable logic circuit, e) a hardware circuit, f) an application-specific circuit, g) a microcontroller, h) a cloud system.

40. The method as recited in claim 30, further comprising:
ascertaining and/or providing and/or at least temporarily storing an identification that characterizes at least one hardware resource of the at least two different hardware resources;
evaluating or validating a configuration of the at least two different hardware resources; and
assessing a validity of results that are obtained using the multiple computing services.

41. The method as recited in claim 30, further comprising:
ascertaining and/or monitoring an integrity of at least one of the following elements: a) at least one computing service of the multiple computing services, b) at least one hardware resource of the at least two different hardware resources, c) at least one processing unit.

42. The method as recited in claim 41, further comprising:
exchanging at least one of the following elements: a) at least one computing service of the multiple computing services, b) at least one hardware resource of the at least two different hardware resources, c) at least one processing unit,
wherein the exchanging takes place when an error has been detected including when a violation of the integrity has been ascertained or detected.

43. The method as recited in claim 30, further comprising:
identifying a faulty component; and
using the faulty component, at least temporarily, to assess a state or integrity of the faulty component.

44. The method as recited in claim 30, further comprising:
shifting a geographical position of at least one of the following elements: a) at least one computing service of the multiple computing services, b) at least one hardware resource of the at least two different hardware resources, c) at least one processing unit;
wherein the shifting is based on at least one of the following elements: A) a geographical position of at least one user of at least one of the multiple computing services, B) a signal propagation time between the at least one user and at least one of the multiple computing services.

45. A device configured to process data, the device configured to:
provide multiple computing services using at least two different hardware resources; and
use the multiple computing services.

46. A cloud system, comprising:
at least one device configured to process data, the device configured to:
provide multiple computing services using at least two different hardware resources, and
use the multiple computing services; and
the at least two different hardware resources.

47. A computer-implemented method for processing data for vehicles, comprising:
using at least one computing service that is provided using a device configured to process data, the device configured to:
provide multiple computing services using at least two different hardware resources; and
use the multiple computing services.

48. The method as recited in claim 47, further comprising:
sending a request for computation of a computation task; and
receiving at least one answer that characterizes a result of the computation.

49. The method as recited in claim 48, further comprising at least one of the following elements:
a) receiving multiple answers, and comparing the multiple answers,
b) receiving multiple answers, and selecting at least one of the multiple answers.

50. The method as recited in claim 49, further comprising:
providing a computation task for a motor vehicle, the computation task to be carried out redundantly and outside the vehicle;
carrying out the computation task redundantly using redundant software resources and/or using redundant hardware resources, and outside the vehicle, using at least two computing services of the multiple computing services, the at least two computing services each being associated with at least one edge server and/or at least one cloud server, and multiple computation results being obtained.

51. The method as recited in claim 50, further comprising:
transferring the multiple computation results to the vehicle.

52. The method as recited in claim 51, further comprising:
receiving the multiple computation results in the vehicle;
comparing the multiple computation results; and
verifying, based on the comparing, the multiple computation results or carrying out a compensation response.

53. A device configured to process data for vehicles, the device configured to:
use at least one computing service that is provided using a first device configured to process data, the first device configured to:
provide multiple computing services using at least two different hardware resources; and
use the multiple computing services.

54. A non-transitory computer-readable memory medium on which are stored commands method for processing data, the commands, when executed by a computer, causing the computer to perform:
providing multiple computing services using at least two different hardware resources; and
using the multiple computing services.

55. A vehicle that includes at least one device for processing data, the device configured to:
provide multiple computing services using at least two different hardware resources; and
use the multiple computing services.

56. The method as recited in claim 30, wherein the method is used for at least one of the following:
a) avoiding a systematic multiple failure,
b) avoiding common cause failures,
c) detecting errors during an execution of a computer program,
d) providing at least one secure computing service and/or at least one secure processing unit via a cloud system and/or via at least one edge server,
e) enabling a secure and/or reliable execution of safety-critical software using a cloud system,
f) transferring safety-critical computations of a vehicle from a system of the vehicle into a remotely situated system including a cloud system and/or an edge computing system and/or at least one edge server,
g) using resources of at least one edge server and/or at least one cloud server for redundantly carrying out a computation task for a vehicle outside vehicle, and assessing computation results that are obtained from the redundant carrying out of computation task including comparing the obtained computation results by a component of the vehicle.
